(19) United States
(12) Patent Application Publication
(10) Pub. No.: US 2005/0236984 A1
(43) Pub. Date: Oct. 27, 2005

(54) Light-emitting device and display device

(76) Inventors: Toshiyuki Aoyama, Osaka (JP); Masayuki Ono, Osaka (JP); Shogo Nasu, Hyogo (JP); Masaru Odagiri, Hyogo (JP)

Correspondence Address: MCDERMOTT WILL & EMERY LLP, 600 13TH STREET, N.W., WASHINGTON, DC, 20005-3096, US

(21) Appl. No.: 11/051,558

(22) Filed: Jan. 27, 2005

(30) Foreign Application Priority Data
Apr. 27, 2004 (JP) P2004-131262

(51) Int. Cl. H05B 33/00

(52) U.S. Cl. 313/509

(57) ABSTRACT

The EL device has a first electrode formed over a substrate, an insulating layer made from a dielectric material having a dielectric constant of 300 or greater formed over the first electrode, a light emitting layer formed over the insulating layer having a film thickness in a range of 10 μm to 100 μm, and a second electrode formed over the light emitting layer.

### BACKGROUND OF THE INVENTION

1. Field of the Invention

The present invention relates to an electroluminescent device, and relates more particularly to an AC-driven electroluminescent device.

2. Background

Electroluminescent devices (“EL devices” below) have become the subject of much interest as a lightweight, thin, surface emitting device. EL devices generally include organic EL devices and inorganic EL devices. Organic EL devices emit light when a DC voltage is applied to an organic phosphor to recombine the electrons and holes to release a photon. Inorganic EL devices emit light when an AC voltage is applied to an inorganic phosphor, causing electrons accelerated by a 10⁶ V/cm high electric field to collide with the emission center and excite the inorganic phosphor, and driving the inorganic phosphor to emit during the course of the relaxation process.

Inorganic EL devices also include dispersion-type EL devices having inorganic phosphor powder dispersed in an organic polymer binder to form the phosphor layer, and thin-film type EL devices having a thin-film phosphor layer with approximately 1 μm thick and a dielectric layer disposed to one or both sides of the thin-film phosphor layer.

Thin-film EL devices with a double insulation construction as proposed by Mr. Inokuchi in 1974 exhibit high luminance and a long life, and have been used for displays in automobiles. The Japanese Patent No. 2009054 discloses that Inorganic EL devices using a ceramic insulating substrate and using a thick-film dielectric layer as one of the insulating layers in this double insulating layer structure are also known. This inorganic EL device has very few insulation breakdowns due to pinholes formed by dust contamination in the manufacturing process. The Japanese Patent Laid-open Publication No. H07-50197 discloses that inorganic EL devices having an insulating layer on only one side of the phosphor layer, and using a thick-film dielectric layer as the insulating layer are also known.

A conventional inorganic EL device is described below with reference to FIG. 3. FIG. 3 is a section view perpendicular to the light-emitting surface of an EL device 50 using a thick-film dielectric layer in a structure having an insulating layer on only one side of the phosphor layer. This EL device 50 has built sequentially on a back substrate 51: back electrode 52, thick-film dielectric layer 53, thin-film phosphor layer 54, transparent electrode 55, and a cover layer 56. Light is obtained through the cover layer 56. The thick-film dielectric layer 53 works to limit insulation breakdown of the EL device 50 by controlling current flow through the thin-film phosphor layer 54, and to acquire stable emission characteristics.

Passive matrix drive display devices are also known. These display devices have transparent electrodes and opposing electrodes patterned in mutually perpendicular stripes. Applying a voltage to specific pixels selected from this electrode matrix, the desired pattern can be displayed on the display devices.

The thin-film phosphor layer 54 is made from zinc sulfide, barium thioaluminate, or yttrium oxide, for example, doped with a metal element, and the film thickness is approximately 1 μm. The device taught in Japanese Patent No. 2009054, for example, uses a 0.3 μm thick film of zinc sulfide doped with manganese for the phosphor layer, and the Japanese Patent Laid-open Publication No. H07-50197 uses a 0.5 μm thick film of zinc sulfide doped with manganese for the phosphor layer. These thin-film phosphor layers are formed by sputtering or vacuum deposition.

The smoothness of the substrate surface is important to forming a defect-free thin-film phosphor layer approximately 1 μm thick, and the Japanese Patent Laid-open Publication No. H07-50197 uses two insulating layers. Productivity drops with this method, however. Cracks also develop easily when forming the film if a thick film is formed by sputtering or vacuum deposition, and it is difficult to achieve a uniform thick film. More basically, sputtering, vacuum deposition, and other vacuum film-forming techniques cannot be said to be high productivity methods.

Because the thick-film insulating layer is a heat annealed ceramic, the surface is relatively rough with a average height of a surface roughness of 0.5 μm to 10 μm. When a thin-film phosphor layer with a film thickness of approximately 1 μm is formed on this thick-film insulating layer, the phosphor layer is directly affected by the surface roughness of the insulating layer, the film thickness of the phosphor layer itself becomes extremely thin, and in some cases separates. The thin part of the phosphor layer is even destroyed in some cases when a high voltage is applied. The electrodes disposed on top of the phosphor layer may even fail.

### SUMMARY OF THE INVENTION

In accordance with one aspect of the present invention, there is an electroluminescent device includes, a substrate, first electrodes formed on the substrate, an insulating layer made from a dielectric material with a dielectric constant of 300 or greater formed over the first electrodes, a phosphor layer of inorganic phosphor powder dispersed in an organic binder formed on the insulating layer, and second electrodes formed on the phosphor layer. Preferably, the film thickness of the phosphor layer is in the range of 10 μm to 100 μm.

By thus forming a phosphor layer with a relatively thick film thickness, asperities in the insulating layer can be completely covered and separation of the phosphor layer can be prevented. Initial defects such as separation of the phosphor layer due to the surface roughness of the insulating layer can also be suppressed.

The film thickness of the insulating layer could be in the range of 5 μm to 200 μm. This insulating layer can be formed by various deposition techniques. The insulating layer could also be made using a ceramic with a perovskite structure. Also, the inorganic phosphor powder forming the phosphor layer could be zinc sulfide doped with a metal element.

The second electrodes are preferably transparent. By using transparent second electrodes, light can be emitted from the second electrode side. As well, the phosphor layer could also contain dye for changing the color of light emitted by the inorganic phosphor powder.

In another aspect of this disclosure is a display device which includes a light-emitting array having a plurality of light-emitting devices in a two-dimensional array, a first plurality of electrodes arranged mutually parallel in a first direction, and a second plurality of electrodes arranged mutually parallel in a second direction that is different from the first direction.

In a further aspect of this disclosure is a method of manufacturing a light-emitting device. The steps include preparing a substrate, forming first electrodes on the substrate, forming an insulating layer made from a dielectric material with a dielectric constant of 300 or greater over the first electrodes, forming a phosphor layer of inorganic phosphor powder dispersed in an organic binder on the insulating layer, and forming second electrodes on the phosphor layer. The step of forming the insulating layer may also include coating a precursor of the dielectric material on the first electrodes, and may further include heating the precursor of the dielectric material.

A light-emitting device in accordance with this disclosure has an insulating layer made from a material with a dielectric constant of 300 or more and a dispersion-type phosphor layer having inorganic phosphor powder dispersed in an organic binder disposed over the insulating layer. This dispersion-type phosphor layer covers the relatively rough asperities of the insulating layer surface, producing a smooth surface that affords a high reliability light-emitting device in which initial defects are suppressed.

By using a dispersion of inorganic phosphor powder in an organic binder for the phosphor layer, and using a dielectric material with a dielectric constant of 300 or greater for the insulating layer, dielectric breakdown is suppressed, initial defects are suppressed, EL devices with stable emission characteristics can be manufactured with high productivity, and production cost can be kept down. Low cost, high reliability EL devices and a display device using the EL devices can thus be provided.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is an exemplary section view perpendicular to the light-emitting surface of an electroluminescent device according to a first embodiment of the present invention;

FIG. 2 is an exemplary schematic plan view showing the structure of a display device according to a second embodiment of the present invention;

FIG. 3 is an exemplary section view perpendicular to the light-emitting surface of an electroluminescent device according to the prior art;

FIG. 4 is an exemplary section view showing a surface roughness of the insulating layer; and

FIG. 5 is a flowchart of method of manufacturing the electroluminescent device.

### DETAILED DESCRIPTION

An EL device and display device according to the present invention are described below with reference to the accompanying figures. Note that functionally like parts are identified by the same reference numerals in the figures.

### FIRST EMBODIMENT

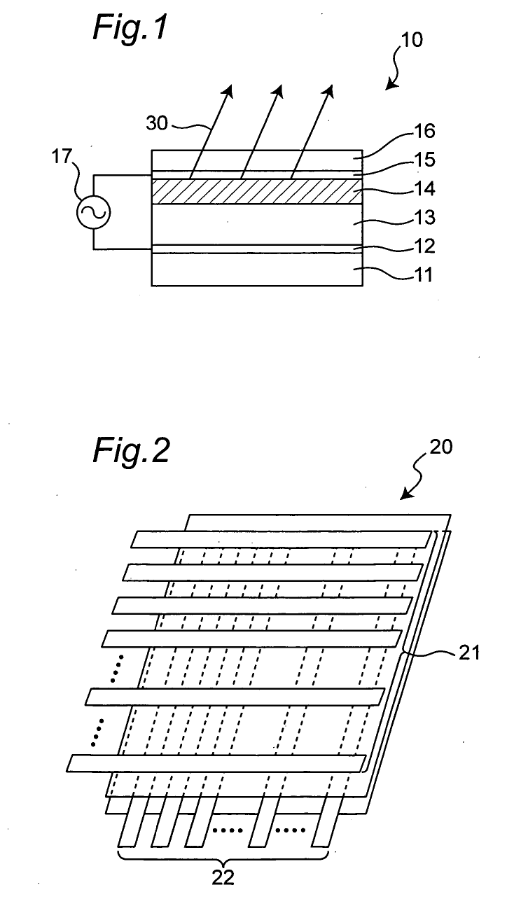

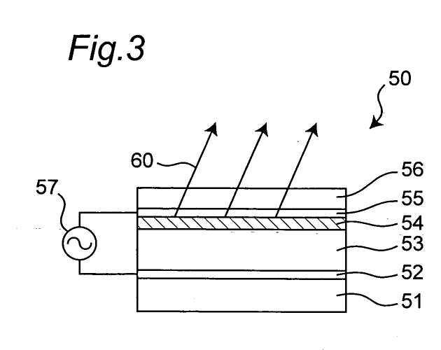

FIG. 1 is a section view perpendicular to the light-emitting surface of an electroluminescent (EL) device 10 according to a first embodiment of the present invention. This EL device 10 has layered in sequence on a back substrate 11: back electrodes 12, an insulating layer 13 made from a dielectric material with a dielectric constant of 300 or higher, a dispersion-type phosphor layer 14 having an inorganic phosphor powder dispersed in an organic binder, a transparent front electrode 15, and a cover layer 16. An AC power source 17 disposed between the front electrode 15 and back electrode 12 supplies an AC voltage to make the dispersion-type phosphor layer 14 emit. The light 30 emitted from the phosphor layer 14 radiates in all directions, and is obtained from the transparent front electrode side in EL device 10. Because the insulating layer 13 is an annealed dielectric material, the surface roughness of the insulating layer 13 in this EL device 10 is extremely coarse with a average height of a surface roughness of 0.5 μm to 10 μm. Therefore, rather than using a thin-film phosphor layer as the phosphor layer, this EL device 10 uses a dispersion-type phosphor layer 14 with a relatively thick film thickness of 10 μm to 100 μm to cover the asperities of the insulating layer 13 and obtain a phosphor layer 14 with a smooth surface. It is thus possible to prevent such defects as separation of the phosphor layer 14 and separation of the second electrodes 15 due to the surface roughness of the insulating layer 13.

The back substrate 11 should be able to withstand the annealing temperature used when forming the above insulating layer 13. If the annealing temperature is 500° C. or less, a glass substrate can be used. If the annealing temperature exceeds 500° C. and is less than or equal to 1000° C., a quartz substrate or ceramic substrate can be used. If the annealing temperature is approximately 1000° C., an alumina or other ceramic substrate can be used.

The back electrodes 12 should be made from a material that retains conductivity even after heat annealing to form the insulating layer thereabove. These back electrodes 12 could be made from a noble metal such as gold, palladium, or platinum, a metal such as chrome, tungsten, or molybdenum, or an alloy of these metals. Metal oxides such as ITO could also be used. These materials are selected according to the annealing temperature and conductivity.

The insulating layer 13 may be made from a ferroelectric material with a dielectric constant of 300 or higher at room temperature. The base dielectric is preferably a ceramic material with a perovskite structure to achieve a high dielectric constant. Examples of such materials include PbNbO₃, BaTiO₃, SrTiO₃, PbTiO₃, Bi₄Ti₃O₁₂, SrBi₂Ta₂O₉, and (Sr, Ca)TiO₃. Resistance to insulation breakdown improves as the film thickness of the dielectric layer increases, but capacitance decreases as thickness increases, and crosstalk between adjacent pixels occurs when used in a display device. A film thickness of 200 μm or less is therefore preferable. On the other hand, if the film thickness is too thin, resistance to insulation breakdown due to reduced film thickness also drops. Furthermore, depending upon the deposition method described below, reducing the film thickness leads to a drop in uniformity during deposition, increased effects from film shrinkage during annealing, and a drop in insulating layer uniformity. A drop in insulating layer uniformity thus leads to a loss of resistance to insulation breakdown. The film thickness of the insulating layer is therefore preferably 10 μm or greater.

Relatively great surface roughness develops in the insulating layer surface when heat annealing is applied after the formation method described below, that is, mixing and stirring a dielectric powder in a binder, and coating the resulting slurry. The surface roughness of the resulting insulating layer depends on the dielectric material, annealing temperature, and film thickness, then the average height of a surface roughness is generally on the order of 0.5 μm to 10 μm.

The dispersion-type phosphor layer 14 has a dispersion structure having inorganic phosphor powder dispersed in an organic binder. A ferroelectric organic material with high electrical insulation properties may be used as the organic binder. The ability to uniformly disperse the phosphor powder in the binder is also necessary. Excellent adhesion with the insulating layer 13 and front electrodes 15 is also desirable. In addition, a material containing few impurities or contaminants that could lead to pinholes or defects, and can easily produce a film of uniform film thickness and quality, is also preferable. Examples of such materials may include: copolymers of polyvinylidene fluoride, vinylidene fluoride, and trifluoroethylene; terpolymers of vinylidene fluoride, trifluoroethylene, and hexafluoropropylene; copolymers of vinylidene fluoride and tetrafluoroethylene; copolymers of vinylidene fluoride oligomer, polyvinyl fluoride (PVF), vinylfluoride, and trifluoroethylene; copolymers of polyacrylonitrile, cyanocelluloses, vinylidene cyanide, and vinyl acetate; and poly(cyanophenylene-sulfide), nylon, and polyurea.

Inorganic phosphors used in the inorganic phosphor powder may include, for example, II-VI compounds (compounds between group II and group VI of elements), such as zinc sulfide and calcium sulfide; thiogallate compounds such as calcium thiogallate; thioaluminate compounds such as barium thioaluminate; metal oxides such as yttrium oxide and gallium oxide; and composite oxides such as Zn₂SiO₄, with such material then activated with a metal element such as manganese. The grain size of the inorganic phosphor powder can be within the range of normally used grain sizes.

The dispersion-type phosphor layer 14 could contain dye for changing the color of light emitted from the inorganic phosphor powder. The dye is not particularly limited, and must simply be able to change the emission color of the inorganic phosphor powder when dispersed in the resin. Examples of such dyes include azo, anthraquinone, anthracene, oxazine, oxazole, xanthene, quinacridone, coumarin, cyanine, stilbene, terphenyl, thiazole, thioindigo, naphthalimide, pyridine, pyrene, diphenylmethane, triphenylmethane, butadiene, phthalocyanine, fluorene, and perylene dyes. A xanthene or cyanine dye is preferably used. More specifically, preferred xanthene dyes include rhodamine B and rhodamine 6G. Preferred cyanine dyes include 4-(dicyanomethylene)-2-methyl-6-(4′-dimethylaminostyryl)-4H-pyran. The dispersion-type phosphor layer 14 could also contain two or more dyes.

The film thickness of the dispersion-type phosphor layer 14 is not specifically limited, and depends upon the grain size of the inorganic phosphor powder, the mixture ratio of the organic binder and inorganic phosphor powder, and the surface roughness of the underlying insulating layer 13. The surface roughness of the underlying insulating layer 13 is at least one of the major factor affecting the smoothness and uniformity of the phosphor layer 14. The film thickness of the dispersion-type phosphor layer 14 is therefore preferably twice the average height of a surface roughness of the insulating layer 13 plus 10 μm. By adding the dispersion-type phosphor layer 14 to a film thickness of twice the average height of a surface roughness of the insulating layer 13 plus 10 μm, the maximum asperities in the insulating layer 13 can be completely covered by the phosphor layer 14, and the surface tension of the binder after deposition is sufficient to produce a smooth surface. A phosphor layer 14 with no film defects can thus be formed.

Conversely, if the film thickness of the dispersion-type phosphor layer 14 is thinner than the foregoing lower limit, the phosphor layer 14 cannot completely cover the maximum asperities in the insulating layer 13, thus leading easily to film defects in the phosphor layer 14 and pinholes in the overlaying front electrodes 15 during deposition. Reliability in terms of resistance to phosphor layer failure thus drops. On the other hand, while increasing the film thickness of the dispersion-type phosphor layer 14 affords easily achieving a uniform film and improved reliability with respect to phosphor layer failure, problems of crosstalk between adjacent pixels and an increase in the drive voltage arise similarly to when the insulating layer becomes thick. The film thickness of the dispersion-type phosphor layer 14 is therefore 100 μm or less.

The film thickness of the dispersion-type phosphor layer 14 is therefore preferably in the range of approximately 10 μm to 100 μm.

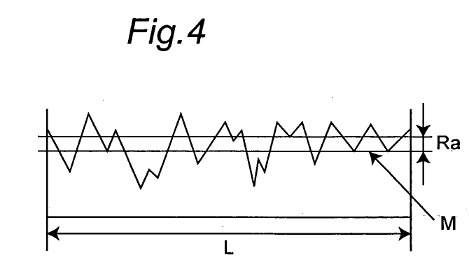

The average height of a surface roughness is described below with reference to FIG. 4. FIG. 4 is a exemplary section view showing a surface roughness of the insulating layer 13.

When x-axis is defined according to the center line M parallel to the surface and y-axis is defined according to a perpendicular direction to the surface as shown in FIG. 4, the surface roughness y is determined based on the center line M as f(x) that is a function as x ranging from 0 to L. It is noted that the center line M shown in FIG. 4 is elongated parallel to the x-axis. Then, an average height of a surface roughness Ra is defined by following equation.

$$Ra = \frac{1}{L} {\int }_{0}^{L} \vert f ( x ) \vert ⅆ x$$

Therefore, the area, which is calculated as integration of f(x), is divided by certain length L to get the average height of the surface roughness Ra.

The front electrodes (second electrodes) 15 must simply be transparent, but preferably have low resistance. ITO (indium tin oxide), InZnO, or SnO₂ are preferably used, but the invention shall not be so limited. In addition, conductive resins such as polyaniline, polypyrrole, and PEDOT/PSS could also be used. The film thickness of the front electrodes 15 is determined according to the required sheet resistance and visible light transmittance.

The cover layer 16 is not essential to light emission, but is preferably provided to cover and protect the front electrodes 15, and thus to protect the EL device 10. Furthermore, because it covers the front electrodes 15, the cover layer 16 is also preferably an insulating layer. The material and thickness of the cover layer 16 are also not particularly limited, and suitable materials include polymers such as polyethylene terephthalate, polyethylene, polypropylene, polyimide, polyamide, and nylon, quartz, and ceramics.

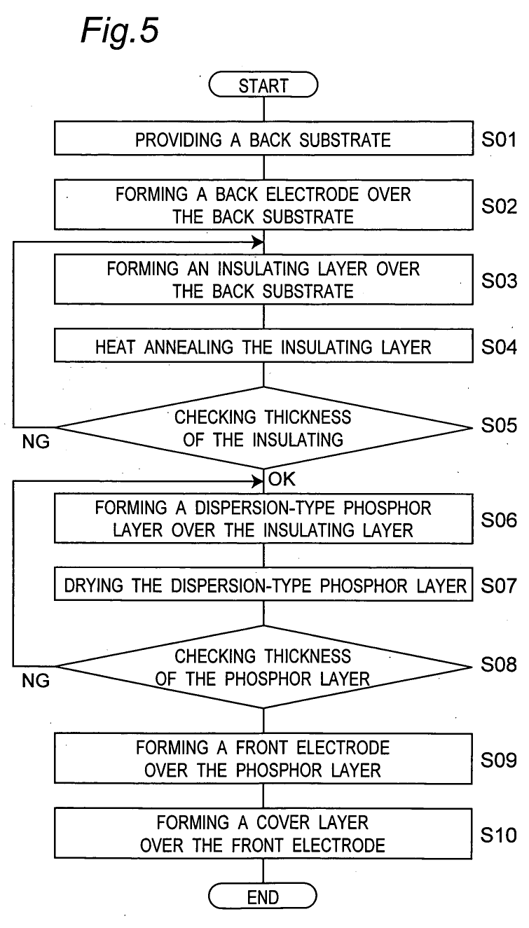

A method of manufacturing this EL device 10 is described next with reference to FIG. 5.

(a) The back substrate 11 is prepared. The back substrate 11 is selected according to the annealing temperature of the insulating layer 13 deposited thereabove. For example, if the annealing temperature is 500° C. or less, a glass substrate can be used. If the annealing temperature exceeds 500° C. and is less than or equal to 1000° C., a quartz substrate or ceramic substrate can be used. If the annealing temperature is approximately 1000° C., an alumina or other ceramic substrate can be used.

(b) The back electrodes 12 are then formed on the back substrate 11. The back electrodes 12 are also selected according to the annealing temperature of the insulating layer 13 formed thereabove.

(c) An insulating layer 13 of a ferroelectric material with a dielectric constant of 300 or higher is then formed over the back electrodes 12. This insulating layer 13 can be formed using known deposition techniques. For example, binder is mixed and blended with the base dielectric material, and a precursor of the dielectric material film is then formed with the selected deposition method, such as casting and doctor blading, or screen printing. After deposition, the precursor of the dielectric material is annealed at a specified temperature, such as 950° C., and the insulating layer is formed from the dielectric material. The film can be deposited multiple times to achieve the desired film thickness.

(d) A dispersion-type phosphor layer 14 having an inorganic phosphor powder dispersed in an organic binder is then formed over the insulating layer 13. The phosphor layer 14 can be formed using known deposition techniques. For example, organic binder is mixed and blended with the inorganic phosphor powder, and a film is then formed with the selected deposition method, such as casting and doctor blading, screen printing, spin coating, inkjet deposition, bar coating, and dip coating. After deposition, the film is dried at a specified temperature, such as 120° C., to form the dispersion-type phosphor layer. This process can be repeated multiple times to achieve the desired film thickness.

(e) The front electrodes (second electrodes) 15 are then formed on the phosphor layer 14. If ITO is used for the front electrodes 15, the electrode film can be deposited using a known technique such as sputtering, electron beam (EB) vapor deposition, and ion plating in order to improve transparency or reduce resistance. Surface treatment such as with plasma processing can be applied after deposition to control the resistance. If a conductive resin is used for the front electrodes 15, the film can be deposited using such known methods as inkjet printing, dipping, spin coating, screen printing, and bar coating.

(f) The cover layer 16 is then formed covering the front electrodes (second electrodes) 15. This cover layer 16 can likewise be formed using such deposition methods as spin coating, inkjet deposition, screen printing, bar coating, and dip coating, or a polymer film or glass plate could be applied. A UV-cure resin could also be coated and then exposed to UV light for curing.

### SECOND EMBODIMENT

A display device according to a second embodiment of the present invention is described next below with reference to FIG. 2. FIG. 2 is a schematic plan view showing a passive matrix display device 20 having mutually perpendicular transparent electrodes 21 and opposing electrodes 22. This display device 20 has a two-dimensional array of multiple EL devices as described in the foregoing first embodiment. Multiple transparent electrodes 21 run parallel to a first direction and parallel to the surface of the EL array, and multiple opposing electrodes 22 run parallel to the EL array surface and parallel to a second direction that is perpendicular to the first direction. In this display device 20, the opposing electrodes 22 are connected to the back electrode of each EL device, and the transparent electrodes 21 are connected to the front electrode of each EL device. An external AC voltage is applied between one transparent electrode 21 and opposing electrode 22 pair to drive one EL device, and light is emitted from the transparent electrode 21 side. EL devices as described above are used as the EL device of each pixel in this display device 20. A low cost electroluminescent display can thus be provided.

A color display device can be provided by depositing separate phosphor layers using RGB phosphors. A different implementation of a color display device could have monochrome or two-color phosphor layers, and color filters and/or color conversion filters could then be used to achieve a RGB display.

It will be apparent that the foregoing embodiments are described by way of example only, and the configuration of the invention shall not be limited to the configurations of the embodiments described above.

The present invention is described in further detail below. Note that this disclosure shall not be limited to the examples described here.

### EXAMPLE 1

An EL device according to this example is substantially identical to the EL device according to the foregoing first embodiment shown in FIG. 1, but differs in that it does not have a cover layer. The method of manufacturing this EL device is described below.

(a) A 0.635 mm thick alumina substrate is used for the back substrate.

(b) A Ag—Pd paste of approximately 85% Ag and approximately 15% Pd is used for the back electrodes, and is screen printed to the back substrate in a striped pattern of 2 mm wide lines at a 3 mm pitch. The paste is then dried and annealed to acquire back electrodes of Ag—Pd alloy on the back substrate.

(c) A paste of BaTiO₃ is used as the precursor of the dielectric material for the insulating layer, and this paste is screen printed over the back electrodes. The paste is then annealed at 950° C. in an air atmosphere to form a BaTiO₃ insulating layer over the back electrodes. The film thickness of the resulting insulating layer was 35 μm, and the center line average height roughness was 2.6 μm.

(d) A ZnS:Cu powder was used for the inorganic phosphor in the dispersion-type phosphor layer, and a copolymer of vinylidene fluoride and tetrafluoroethylene was used for the organic binder. The phosphor powder and organic binder solution were mixed at a 1:1 weight ratio and stirred well, and the resulting slurry was deposited on the insulating layer using a screen printing method. The slurry was then dried at 120° C. in an air atmosphere to acquire a dispersion-type phosphor layer. The film thickness of this dispersion-type phosphor layer was 28 μm.

(e) The front electrodes were formed by depositing a 0.4 μm thick ITO film using EB vapor deposition. After deposition, a transparent striped pattern was formed by etching 2 mm wide stripes at a 3 mm pitch perpendicularly to the back electrodes.

The cover layer was not formed.

### EXAMPLE 2

Compared with the EL device of the foregoing examplet 1, an EL device according to this example 2 features the same construction as the EL device of example 1, but differs in the dielectric material used in the insulating layer, and the inorganic phosphor powder of the dispersion-type phosphor layer. The manufacturing method of this EL device is described below.

(a) A 0.635 mm thick alumina substrate is used for the back substrate as in example 1.

(b) For the back electrodes, back electrodes of Ag—Pd alloy are formed on the back substrate as in example 1.

(c) A paste of PbNbO₃ is used as the precursor of the dielectric material for the insulating layer, and this paste is screen printed over the back electrodes. The paste is then dried at 200° C. in an air atmosphere and heat annealed at 950° C. to acquire a PbNbO₃ insulating layer. The film thickness of the resulting insulating layer was 48 μm, and the center line average height roughness was 9.2 μm.

(d) A ZnS:Mn powder was used for the inorganic phosphor in the dispersion-type phosphor layer, and a copolymer of vinylidene fluoride and tetrafluoroethylene was used for the organic binder. The phosphor powder and organic binder solution were mixed at a 1:1 weight ratio and stirred well, and the resulting slurry was deposited on the insulating layer using a screen printing method. The slurry was then dried at 120° C. in an air atmosphere to acquire a dispersion-type phosphor layer. The film thickness of this dispersion-type phosphor layer was 30 μm.

(e) The front electrodes were using a 0.4 μm thick ITO film as in example 1. After deposition, a transparent striped pattern was formed by etching 2 mm wide stripes at a 3 mm pitch perpendicularly to the back electrodes.

The cover layer was not formed.

### COMPARISON EXAMPLE

The EL devices in this comparison example differ from the EL devices of the foregoing examples 1 and 2 in that a thin-film phosphor layer formed by vapor deposition was used for the phosphor layer. The method of manufacturing the EL device according to this comparison example is described below. That is, from the back substrate to the insulating layer are the same as in example 1, and for the phosphor layer, ZnS and Mn were deposited by vapor codeposition on the insulating layer to form a ZnS:Mn film 0.4 μm thick. After deposition the film was heat treated in an Ar atmosphere for 2 hours at 650° C. The back electrodes were then formed as in example 1, and the EL device was acquired.

Display devices were then manufactured using EL devices produced according to examples 1 and 2, and the comparison example. Luminance when a 150 V/600 Hz sine wave AC voltage was applied to the resulting display devices, the presence of initial defects, and insulation resistance to a 300-V applied voltage were tested. The results are shown in Table 1.

TABLE 1

| | Luminance (cd/m²) | Initial defects | Insulation resistance |
|---|---|---|---|
| Example 1 | 500 | none | good |
| Example 2 | 400 | none | good |
| Comparison | 400 | yes | poor |

As shown in Table 1, with respect to initial defects and luminance when 150 V/600 Hz sine wave AC voltage was applied, the display devices of examples 1 and 2, and the comparison example, exhibited a good luminance characteristic of 400 cd/m² or more. With respect to initial defects, however, there were no initial defects with the EL devices according to examples 1 and 2, but non-emitting pixels were observed in the display device using the EL devices of the comparison example, and initial defects were thus present.

Furthermore, in the insulation resistance test to applied voltages of 300 V, there were no non-emitting pixels detected in the display devices using EL devices according to examples 1 and 2, but in the display device using EL devices according to the comparison example, the initially defective non-emitting portion was observed to grow with newly non-emitting pixels detected. The newly non-emitting portion is believed to result from failure of the thin-film phosphor layer. As described above, the display devices using EL devices according to examples 1 and 2 of the present invention exhibited high reliability.

A light-emitting device according to the present invention uses a dielectric material with a dielectric constant of 300 or higher for the insulating layer, and uses a dispersion-type phosphor layer with inorganic phosphor powder dispersed in an organic binder as the phosphor layer. The resulting light-emitting device as a low cost, high reliability electroluminescent device for surface illumination and backlights for liquid crystal panels, and for flat panel displays.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

1. An electroluminescent device comprising:
a first electrode formed over a substrate;
an insulating layer made from a dielectric material having a dielectric constant of 300 or greater formed over the first electrode;
a light emitting layer formed over the insulating layer having a film thickness in a range of 10 μm to 100 μm; and
a second electrode formed over the light emitting layer.

2. The electroluminescent device according to claim 1, wherein a thickness of the light emitting layer is at least two times greater than an average height of a surface roughness of the insulating layer.

3. The electroluminescent device according to claim 2, wherein the average height is in a range of 0.5 μm to 10 μm.

4. The electroluminescent device according to claim 1, wherein a thickness of the insulating layer is in a range of 5 μm to 200 μm.

5. The electroluminescent device according to claim 1, wherein the insulating layer is made from a ceramic with a perovskite structure.

6. The electroluminescent device according to claim 1, wherein the light emitting layer is a phosphor layer.

7. The electroluminescent device according to claim 6, wherein the phosphor layer is made of inorganic phosphor powder dispersed in an organic binder.

8. The electroluminescent device according to claim 1, wherein the inorganic phosphor powder forming the phosphor layer is zinc sulfide doped with a metal element.

9. The electroluminescent device according to claim 7, wherein the light emitting layer contains a dye for changing a color of light emitted by the inorganic phosphor powder.

10. The electroluminescent device according to claim 1, wherein the second electrodes is transparent.

11. An electroluminescent device comprising:
a first electrode formed over a substrate;
an insulating layer made from a dielectric material with a dielectric constant of 300 or greater formed over the first electrode;
a light emitting layer formed over the insulating layer having a film thickness which is at least two times greater than an average height of a surface roughness of the insulating layer; and
a second electrode formed over the light emitting layer.

12. The electroluminescent device according to claim 11, wherein a thickness of the insulating layer is in a range of 5 μm to 200 μm.

13. The electroluminescent device according to claim 11, wherein the insulating layer is made from a ceramic with a perovskite structure.

14. The electroluminescent device according to claim 11, wherein the light emitting layer is a phosphor layer.

15. The electroluminescent device according to claim 14, wherein the phosphor layer is made of inorganic phosphor powder dispersed in an organic binder.

16. The electroluminescent device according to claim 15, wherein the inorganic phosphor powder forming the phosphor layer is zinc sulfide doped with a metal element.

17. The electroluminescent device according to claim 15, wherein the light emitting layer contains a dye for changing a color of light emitted by the inorganic phosphor powder.

18. The electroluminescent device according to claim 11, wherein the second electrode is transparent.

19. The electroluminescent device according to claim 11, wherein the insulating layer has the surface roughness with the average height in a range of 0.5 μm to 10 μm.

20. A method of manufacturing a light-emitting device comprising the steps of:
forming a first electrode over a substrate;
forming a dielectric layer having a dielectric constant of 300 or greater over the first electrode;
forming a light-emitting layer having a thickness that is at least two times greater than an average height of a surface roughness of the dielectric layer; and
forming a second electrode on the light-emitting layer.

21. The method of manufacturing a light-emitting device according to claim 20, further comprising the step of dispersing an inorganic phosphor powder in an organic binder for forming the light-emitting layer.

22. The method of manufacturing a light-emitting device according to claim 21, further comprising the step of doping the light-emitting layer with zinc sulfide doped and a metal element.

23. The method of manufacturing a light-emitting device according to claim 20, wherein the step of forming the dielectric layer comprises the steps of:
coating a precursor of dielectric material on the first electrode; and
annealing the precursor of dielectric material.

24. The method of manufacturing a light-emitting device according to claim 20, further comprising the step of forming a cover layer over the second electrode.

25. A display device comprising:
a light-emitting array having a plurality of light-emitting devices;
a first plurality of electrodes arranged mutually parallel in a first direction; and
a second plurality of electrodes arranged mutually parallel in a second direction that is different from the first direction,
wherein each light-emitting device of the plurality of light-emitting devices comprises,
a first electrode formed over a substrate,
an insulating layer made from a dielectric material having a dielectric constant of 300 or greater formed over the first electrode,
a light emitting layer formed over the insulating layer having a film thickness in a range of 10 μm to 100 μm, and
a second electrode formed over the emitting layer.

26. The display device according to claim 25, wherein the first direction is substantially perpendicular to the second direction.

27. The display device according to claim 25, wherein the first plurality of electrodes and the second plurality of electrodes are substantially parallel to a light-emitting surface of the light-emitting array.

28. The display device according to claim 25, wherein the plurality of first electrodes traverse the plurality of second electrodes.

29. The display device according to claim 28, wherein the plurality of first electrodes are transparent.

30. The display device according to claim 25, wherein
each of the first plurality of electrodes are connected to a corresponding first electrode of each light-emitting device, and
each of the second plurality of electrodes are connected to a corresponding second electrode of each light-emitting device.

31. A display device comprising:
a light-emitting array having a plurality of light-emitting devices;
a first plurality of electrodes arranged mutually parallel in a first direction; and
a second plurality of electrodes arranged mutually parallel in a second direction that is different from the first direction,
wherein each light-emitting device of the plurality of light-emitting devices comprises,
a first electrode formed over a substrate,
an insulating layer made from a dielectric material with a dielectric constant of 300 or greater formed over the first electrode,
a light emitting layer formed over the insulating layer having a film thickness which is at least two times greater than an average height of a surface roughness of the insulating layer, and
a second electrode formed over the emitting layer.

32. The display device according to claim 31, wherein the first direction is substantially perpendicular to the second direction.

33. The display device according to claim 31, wherein the first plurality of electrodes and the second plurality of electrodes are substantially parallel to a light-emitting surface of the light-emitting array.

34. The display device according to claim 31, wherein the plurality of first electrodes traverse the plurality of second electrodes.

35. The display device according to claim 34, wherein the plurality of first electrodes are transparent.

36. The display device according to claim 31, wherein
each of the first plurality of electrodes are connected to a corresponding first electrode of each light-emitting device, and
each of the second plurality of electrodes are connected to a corresponding second electrode of each light-emitting device.
